(19) United States
(12) Patent Application Publication
(10) Pub. No.: US 2026/0356312 A1
(43) Pub. Date: Nov. 12, 2026

(54) DEVICE FOR PREVENTING AN UNDERRIDE COLLISION

(71) Applicant: Volkswagen Aktiengesellschaft, Wolfsburg (DE)

(72) Inventors: Victor Preu, Wolfsburg (DE); Steve Simon, Wolfsburg (DE); Patrick Sacher, Wolfsburg (DE); Roman Putter, Wolfsburg (DE); Witali Effenberger, Wolfsburg (DE)

(21) Appl. No.: 19/556,599

(22) Filed: Mar. 4, 2026

(30) Foreign Application Priority Data
Mar. 10, 2025 (DE) 102025108861.6

(51) Int. Cl. B60R 19/56

(52) U.S. Cl. CPC B60R 19/56

(57) ABSTRACT

Technologies and techniques are provided for preventing an underride collision between a first vehicle and a second vehicle, wherein the second vehicle includes an underride area. A device is communicatively connected to a surroundings sensor system and an evaluation unit for data exchange. The surroundings sensor system and the evaluation unit are configured to predict an unavoidable underride collision. In response to predicting the unavoidable underride collision, the device is configured to actuate a protective mechanism that prevents the first vehicle from sliding beneath the second vehicle.

### RELATED APPLICATIONS

The present application claims priority to German Patent App. No. 102025108861.6, to Preu et al., filed Mar. 10, 2025, the contents of which are incorporated by reference in its entirety herein.

### TECHNICAL FIELD

The present disclosure relates to vehicle safety systems. More particularly, the present disclosure relates to a device for preventing an underride collision between a first vehicle and a second vehicle, wherein the second vehicle has an underride area.

### BACKGROUND

Modern road traffic typically involves mixed traffic in which vehicles of varying sizes and designs operate together. In particular, passenger cars and trucks commonly share roadways. Passenger cars are generally designed to accommodate approximately one to nine occupants and typically have a comparatively low seat height above the roadway of approximately 0.4 m to 1 m. Trucks, in contrast, are generally configured as commercial vehicles for transporting heavy loads and include a cargo area positioned at a height of approximately 1 m to 1.5 m above the roadway surface. This difference in height can be critical in the event of a collision between a passenger car and a truck because the comparatively high cargo area of the truck forms an underride area relative to the passenger car. As a result, an impact between a passenger car and a truck may not be absorbed by a crumple zone of the passenger car. In particular, during an underride collision the vehicle body of the passenger car may collide with the edge of the cargo area of the truck in the region of the A-pillars, which are generally not designed to withstand such loads, thereby often resulting in accidents associated with significant personal injury.

To reduce the effects of such underride collisions, trucks are commonly equipped with underride guards. For example, known underride guards may be designed as bars having at least one cross member that delimits the space between the cargo area and the roadway while maintaining a required minimum distance from the roadway surface. In side regions of a truck, particularly between the wheels, the cross member of the underride guard may extend to just above the contact plane. In contrast, the required minimum distance from the roadway is comparatively large in the rear region of the truck so that the underride guard does not contact the roadway when the roadway includes varying grades. In addition, such bar-type structures may provide limited structural stability. As a result, these systems may offer insufficient protection, particularly in collisions involving large speed differences.

Further devices for preventing underride collisions are known from the prior art, for example from DE 10 2022 105 078 A1, WO 2007/0102755 A1, and KR 10 2005 019 640 A. However, these known systems may not provide sufficient protection to effectively reduce the consequences of underride collisions or to meaningfully reduce the risk of injury to road users.

### SUMMARY

Against this background, some aspects of the present disclosure relate to a device for preventing an underride collision between a first vehicle and a second vehicle. In some examples, the device is configured to reduce the effects of an underride collision and thereby reduce the risk of injury to road users.

In some examples, a device for preventing an underride collision between a first vehicle and a second vehicle is provided, wherein the second vehicle has an underride area. The device is connected to a surroundings sensor system and an evaluation unit for data exchange. The combination of the surroundings sensor system and the evaluation unit is configured to predict an unavoidable underride collision. In response to the prediction of an unavoidable underride collision, the device is configured to prevent the first vehicle from sliding beneath the second vehicle by actuating a protective device.

In some examples, the first vehicle may be configured as a passenger car. The second vehicle may be configured as a commercial vehicle, such as a truck, a truck with a trailer, a truck with a semi-trailer, or an agricultural commercial vehicle.

Surroundings sensor systems in combination with evaluation units are known in connection with vehicle-internal restraint systems and emergency braking assistance systems for reducing the consequences of unavoidable collisions. In some examples, such sensor systems and evaluation units may be used for the prevention of underride collisions. By predicting an unavoidable underride collision and activating a corresponding protective measure, the effects of an underride collision may be reduced, thereby reducing the risk of injury to road users.

Additional features and refinements of the present disclosure will be described in further detail below and may be reflected in the appended claims.

### BRIEF DESCRIPTION OF THE DRAWINGS

Specific examples of the present disclosure are described below with reference to the accompanying drawings.

FIG. 1a illustrates a first traffic situation including a first vehicle and a second vehicle, according to some aspects of the present disclosure;

FIG. 1b, a) illustrates a second traffic situation including a first vehicle and a second vehicle in a passive state of a protective structure, and FIG. 1b, b) illustrates the second traffic situation of FIG. 1b, a), wherein a protective structure is in an active state, according to some aspects of the present disclosure;

FIG. 1c, a) illustrates a third traffic situation including a first vehicle and a second vehicle, and FIG. 1c, b) illustrates the third traffic situation of FIG. 1c, a), wherein the protective structure is in an active state, according to some aspects of the present disclosure;

FIG. 2a illustrates a fourth traffic situation including a first vehicle and a second vehicle, according to some aspects of the present disclosure; and

FIG. 2b, a) illustrates a fifth traffic situation including a first vehicle and a second vehicle in a passive state of a protective structure, and FIG. 2b, b) illustrates the fifth traffic situation of FIG. 2b, a), wherein the protective structure is in an active state, according to some aspects of the present disclosure.

### DETAILED DESCRIPTION

In some examples disclosed herein, the device may be configured as a reversible actuator system or an irreversible actuator system of the first vehicle. The actuator system may be configured to raise the first vehicle such that a collision between the first vehicle and the second vehicle occurs outside the underride area. Raising the first vehicle may cause the first vehicle to collide with the second vehicle above the underride area, and in particular above a lower edge of the cargo area, where the second vehicle may include structural elements delimiting the cargo area. A collision with these regions may allow a crumple zone of the first vehicle to absorb impact energy by converting kinetic energy during the impact into deformation energy. In this manner, an underride collision may be prevented, and in particular a collision between the edge of the cargo area and the A-pillars of the first vehicle may be avoided.

In some examples, the reversible actuator system may be configured as an electric actuator system, a pneumatic actuator system, or a hydraulic actuator system. For example, the reversible actuator system may include an air suspension system, an adaptive chassis control system, or a system configured to adjust a brake load distribution between front and rear axles.

When the reversible actuator system includes an air suspension system, a pneumatic suspension system associated with the front axle of the vehicle may be used to raise the vehicle. Alternatively, the vehicle may be raised at both the front axle and the rear axle.

In some vehicle configurations, a brake load applied to the front axle may be greater than a brake load applied to the rear axle, for example with a ratio of approximately 60/40. During a braking process, this configuration may cause the front axle to lower and the rear axle to rise. By shifting the brake load toward the rear axle, for example shortly before an unavoidable collision, this effect may be reversed or reduced.

In some examples, the irreversible actuator system may be configured as a pyrotechnic device. The pyrotechnic device may generate at least one controlled explosion, the resulting pressure wave being directed such that a pulse is generated that accelerates the vehicle upward. This configuration may enable a comparatively rapid height adjustment relative to reversible actuator systems, which may allow a shorter response time prior to a predicted collision.

In some examples, the device may be configured as a protective structure of the first vehicle that is movable from a passive position to an active position. The passive position may correspond to a retracted configuration and the active position may correspond to an extended configuration. Multiple structural implementations of the protective structure may be used.

In some examples, the protective structure may include an airbag. The airbag may be positioned in a front bumper region of the first vehicle and may be deployable in a longitudinal direction of a vehicle coordinate system. A height of the deployed airbag may be selected such that the deployed airbag extends beyond the underride area of typical second vehicles, thereby preventing the first vehicle from entering the underride area.

In some examples, the protective structure may additionally or alternatively include a plurality of telescopic rods. The telescopic rods may be retracted in the passive position and extended in the active position such that the telescopic rods form a cage structure. The telescopic rods may be arranged, for example, within the roof and/or hood of the first vehicle so that, when extended, the rods form a cage between the vehicle cabin and the underride area of the second vehicle. This configuration may prevent the first vehicle from penetrating into the underride area of the second vehicle.

In some examples, the device may be configured as a reversible actuator system or an irreversible actuator system of the second vehicle. The actuator system may be configured to lower the second vehicle such that a collision between the first vehicle and the second vehicle occurs outside the underride area.

In some examples, the reversible actuator system of the second vehicle may be configured as an electric actuator system, a pneumatic actuator system, or a hydraulic actuator system. Alternatively, the irreversible actuator system may be configured as a pyrotechnic device.

In some examples, the device may include a protective structure associated with the second vehicle that is movable from a passive position to an active position. In some configurations, the protective structure may include an airbag positioned at a rear region of the second vehicle such that deployment of the airbag fills the underride area and prevents the first vehicle from entering the underride area. For example, the folded airbag may be positioned on an underside of the cargo area of the second vehicle prior to deployment.

In some examples, the surroundings sensor system may include sensors arranged on the first vehicle, on the second vehicle, or within a traffic infrastructure.

In some examples, the first vehicle and the second vehicle may be configured to exchange data either directly via car-to-car (C2C) communication or indirectly via car-to-infrastructure (C2X) communication. In some configurations, at least some of the sensors may include radar sensors and/or camera sensors.

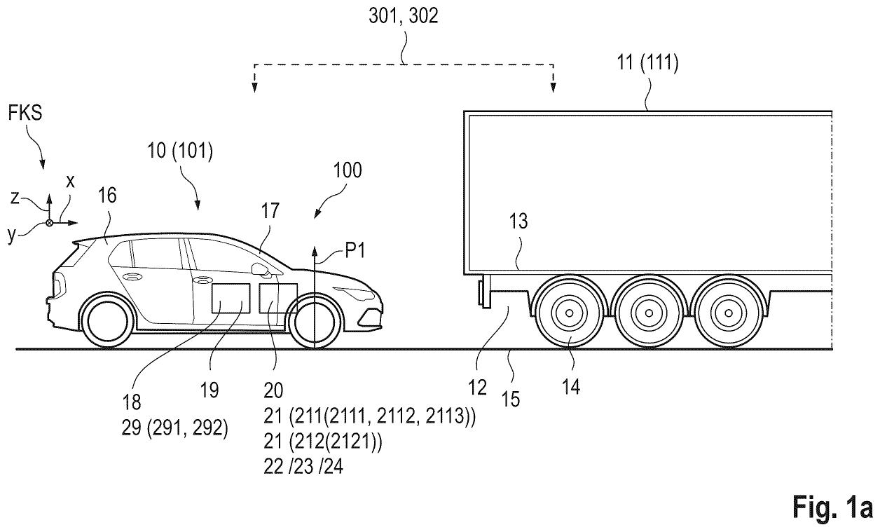

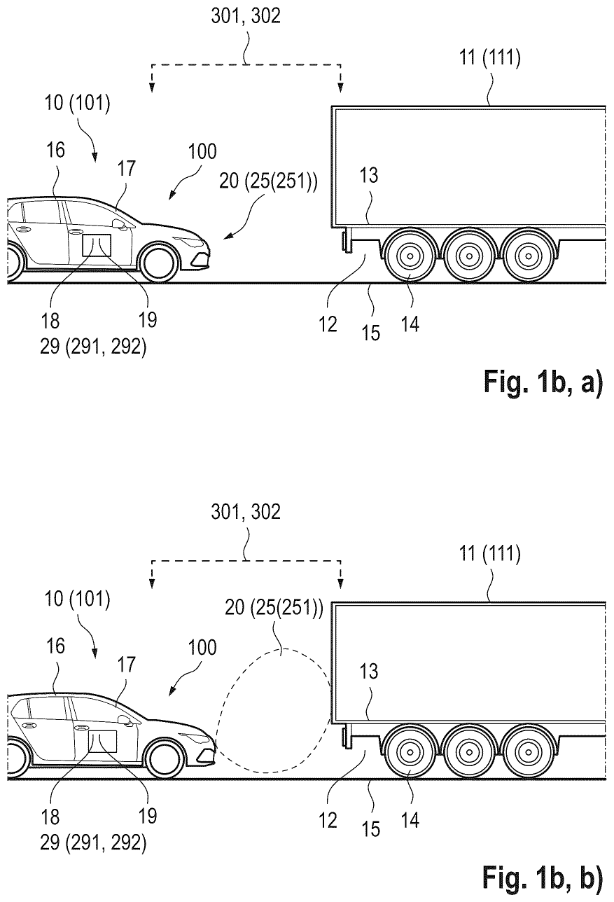

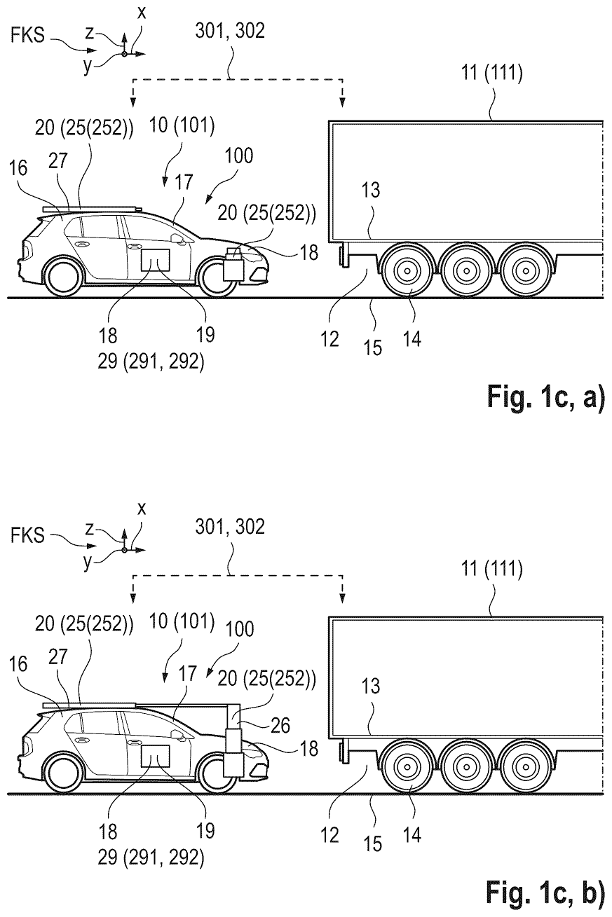

FIG. 1a illustrates a first traffic situation in which a first vehicle 10, shown as a passenger car 101 in the illustrated example, follows a second vehicle 11, shown as a truck 111. The first vehicle 10 includes a device 100 configured to prevent an underride collision between the first vehicle 10 and the second vehicle 11, wherein the second vehicle 11 includes an underride area 12. In the illustrated example, the underride area 12 corresponds to a region of the second vehicle 11 that is bounded at an upper side by a cargo area 13 of the truck 111, toward a forward side by edges 14 of the truck 111, and toward a lower side by a roadway surface 15. Directional references correspond to a vehicle coordinate system FKS. The underride area 12 may present a safety risk in the event of a rear-end collision because the first vehicle 10 may enter the underride area 12, causing a vehicle cabin 16 of the first vehicle 10 to collide with a rear edge of the cargo area 13 in a region of A-pillars 17. Such an impact configuration may lead to severe vehicle damage and personal injury.

The device 100 is communicatively connected to a surroundings sensor system 18 and an evaluation unit 19 for data exchange. The combination of the surroundings sensor system 18 and the evaluation unit 19 may be configured to predict an unavoidable underride collision. In response to such a prediction, the device 100 may actuate a device 20 configured to prevent the first vehicle 10 from sliding beneath the second vehicle 11.

In the example illustrated in FIG. 1a, the device 20 is configured as an actuator system 21 associated with the first vehicle 10. The actuator system 21 may raise the first vehicle 10 in a direction indicated by arrow P1 such that a collision between the first vehicle 10 and the second vehicle 11 occurs outside the underride area 12. In the illustrated configuration, the predicted collision between the first vehicle 10 and the second vehicle 11 may occur above the cargo area 13 so that an energy absorption function of a crumple zone of the first vehicle 10 may be utilized.

The actuator system 21 may include various actuator configurations configured to raise the first vehicle 10. For example, the actuator system 21 may include reversible actuator systems 211 and irreversible actuator systems 212. The reversible actuator systems 211 may include electric actuator systems 2111, pneumatic actuator systems 2112, or hydraulic actuator systems 2113. In some examples, these systems may be implemented using an air suspension system 22, an adaptive chassis control system 23, or a system configured to adjust brake load distribution between front and rear axles using a change device 24. An irreversible actuator system 212 may include, for example, a pyrotechnic device 2121.

FIGS. 1b, a), 1b, b), 1c, a), and 1c, b) illustrate additional examples in which the device 20 is configured as a protective structure 25 of the first vehicle 10. The protective structure 25 may be movable from a passive position to an active position, where the passive position corresponds to a retracted configuration and the active position corresponds to an extended configuration.

In the example illustrated in FIGS. 1b, a) and 1b, b), the protective structure 25 includes an airbag 251. In a folded configuration, the airbag 251 may be stored within a front bumper region of the first vehicle 10, as illustrated in FIG. 1b, a), and may be connected to a compressed air source, such as a compressed air cylinder or compressor (not shown). When an unavoidable underride collision is detected, the airbag 251 may be deployed using the compressed air source such that the airbag expands into the underride area 12 and prevents the first vehicle 10 from entering the underride area 12, as illustrated in FIG. 1b, b).

In the example illustrated in FIGS. 1c, a) and 1c, b), the protective structure 25 includes a plurality of telescopic rods 252. The telescopic rods 252 may be retracted in the passive position, as illustrated in FIG. 1c, a), and extended in the active position, as illustrated in FIG. 1c, b), so that the rods form a cage structure 26. In some configurations, the telescopic rods 252 may be arranged within a roof 27 and/or a hood 28 of the first vehicle 10. When extended, the telescopic rods 252 form the cage 26 between the vehicle cabin 16 and the underride area 12 of the second vehicle 11, thereby preventing the first vehicle 10 from penetrating the underride area 12.

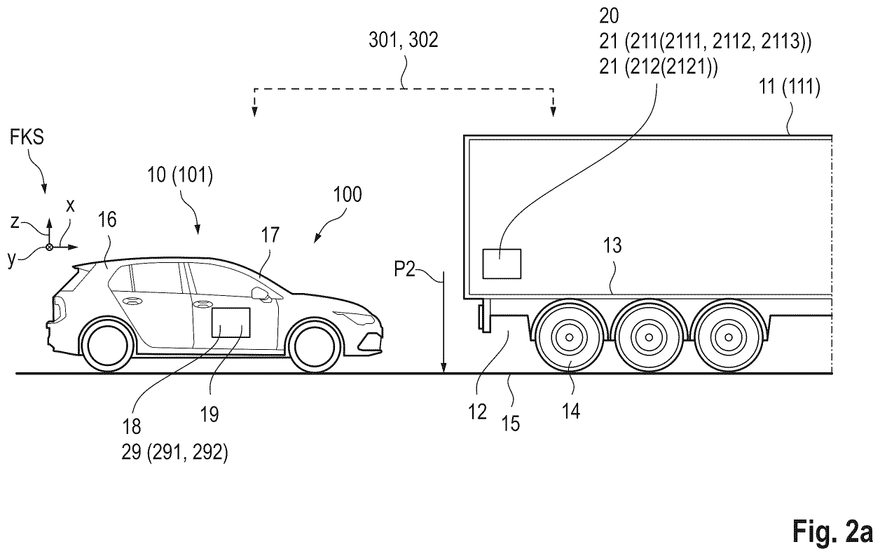

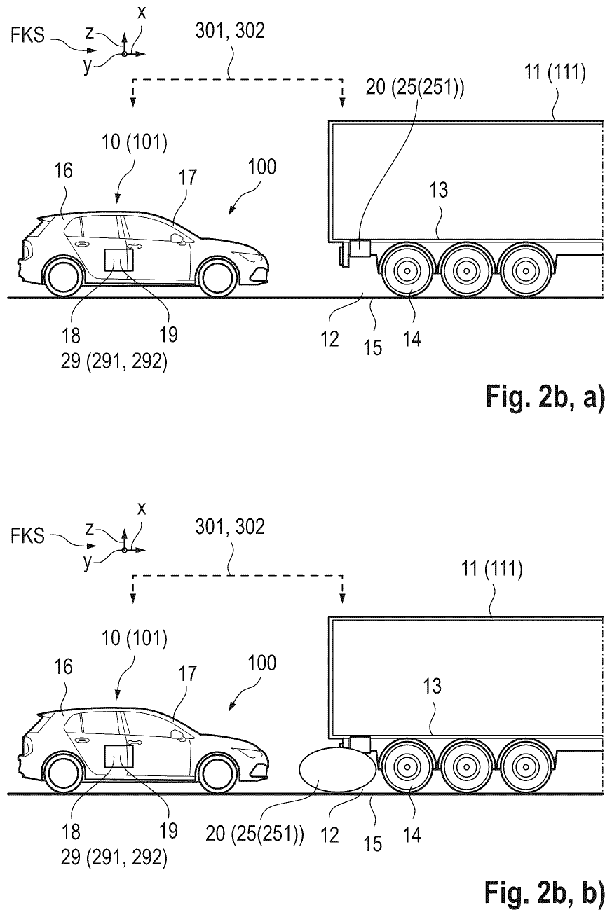

In additional examples illustrated in FIGS. 2a, 2b, a), and 2b, b), the device 20 may be configured as a reversible actuator system 211 or an irreversible actuator system 212 associated with the second vehicle 11.

In the configuration illustrated in FIG. 2a, the actuator system 21 may lower the second vehicle 11 in a direction indicated by arrow P2 so that a collision between the first vehicle 10 and the second vehicle 11 occurs outside the underride area 12. The reversible actuator system 211 may include an electric actuator system 2111, a pneumatic actuator system 2112, or a hydraulic actuator system 2113. The irreversible actuator system 212 may include a pyrotechnic device 2121.

In the configuration illustrated in FIGS. 2b, a) and 2b, b), the device 20 includes a protective structure 25 associated with the second vehicle 11 that is movable from a passive position, as illustrated in FIG. 2b, a), to an active, as illustrated in FIG. 2b, b). In the illustrated example, the protective structure 25 includes an airbag 251 connected to a compressed air source such as a compressed air cylinder or compressor (not shown). When an unavoidable underride collision is detected, the airbag may be deployed so that the underride area 12 is filled and the first vehicle 10 is prevented from entering the underride area 12.

Regardless of the specific embodiment of the device 20, the surroundings sensor system 18 may include sensors 29 arranged on the first vehicle 10, as illustrated in FIGS. 1a, 1b, a), 1b, b), 1c, a), and 1c, b), on the second vehicle 11, as illustrated in FIGS. 2a, 2b, a), and 2b, b), or within a traffic infrastructure.

In some examples, the first vehicle 10 and the second vehicle 11 may be configured to exchange data either directly via car-to-car (C2C) communication 301 or indirectly via car-to-infrastructure (C2X) communication 302. In some configurations, at least some of the sensors 29 may include radar sensors 291 and/or camera sensors 292.

List of Reference Symbols

| | |
|---|---|
| 100 | device |
| 10 | first vehicle |
| 101 | passenger car |
| 11 | second vehicle |
| 111 | truck |
| 12 | underride area |
| 13 | cargo area |
| 14 | wheel |
| 15 | roadway surface |
| 16 | vehicle cabin |
| 17 | A pillar |
| 18 | surroundings sensor system |
| 19 | evaluation unit |
| 20 | device |
| 21 | actuator system |
| 211 | reversible actuator system |
| 2111 | electric actuator system |
| 2112 | pneumatic actuator system |
| 2113 | hydraulic actuator system |
| 212 | irreversible actuator system |
| 2121 | pyrotechnic device |
| 22 | air suspension system |
| 23 | adaptive chassis control system |
| 24 | change device |
| 25 | protective structure |
| 251 | airbag |
| 252 | telescopic rods |
| 26 | cage |
| 27 | roof |
| 28 | hood |
| 29 | sensor |
| 291 | radar sensor |
| 292 | camera sensors |
| 301 | C2C communication |
| 302 | C2X communication |
| P1 | direction of arrow |
| P2 | direction of arrow |
| FKS | vehicle coordinate system |

1. A device for preventing an underride collision between a first vehicle and a second vehicle, the second vehicle including an underride area, the device comprising:
a surroundings sensor system configured to detect an environment surrounding the first vehicle;
an evaluation unit communicatively coupled to the surroundings sensor system and configured to determine, based on sensor data from the surroundings sensor system, whether an unavoidable underride collision between the first vehicle and the second vehicle is predicted; and
a collision mitigation device configured to be actuated in response to prediction of the unavoidable underride collision, whereby the first vehicle is prevented from entering the underride area of the second vehicle.

2. The device of claim 1, wherein the collision mitigation device comprises an actuator system associated with the first vehicle and configured to raise the first vehicle so that a collision between the first vehicle and the second vehicle occurs outside the underride area.

3. The device of claim 2, wherein the actuator system comprises a reversible actuator system.

4. The device of claim 3, wherein the reversible actuator system comprises at least one of an electric actuator system, a pneumatic actuator system, or a hydraulic actuator system.

5. The device of claim 4, wherein the reversible actuator system comprises at least one of an air suspension system, an adaptive chassis control system, or a system configured to adjust brake load distribution between a front axle and a rear axle of the first vehicle.

6. The device of claim 2, wherein the actuator system comprises an irreversible actuator system.

7. The device of claim 6, wherein the irreversible actuator system comprises a pyrotechnic device configured to generate a force that accelerates the first vehicle upward.

8. The device of claim 1, wherein the collision mitigation device comprises a protective structure associated with the first vehicle and movable between a passive position and an active position.

9. The device of claim 8, wherein the protective structure comprises an airbag deployable from a front bumper region of the first vehicle.

10. The device of claim 8, wherein the protective structure comprises a plurality of telescopic rods configured to extend from at least one of a roof or a hood of the first vehicle to form a cage structure.

11. The device of claim 1, wherein the collision mitigation device comprises an actuator system associated with the second vehicle and configured to lower the second vehicle so that a collision between the first vehicle and the second vehicle occurs outside the underride area.

12. The device of claim 11, wherein the actuator system comprises a reversible actuator system including at least one of an electric actuator system, a pneumatic actuator system, or a hydraulic actuator system.

13. The device of claim 11, wherein the actuator system comprises an irreversible actuator system comprising a pyrotechnic device configured to lower the second vehicle.

14. The device of claim 1, wherein the collision mitigation device comprises a protective structure associated with the second vehicle and movable between a passive position and an active position.

15. The device of claim 14, wherein the protective structure comprises an airbag deployable beneath a cargo area of the second vehicle to fill the underride area.

16. A method for preventing an underride collision between a first vehicle and a second vehicle, the second vehicle including an underride area, the method comprising:
detecting an environment surrounding the first vehicle using a surroundings sensor system;
determining, using an evaluation unit, whether an unavoidable underride collision between the first vehicle and the second vehicle is predicted based on sensor data from the surroundings sensor system; and
actuating a collision mitigation device in response to predicting the unavoidable underride collision, whereby the first vehicle is prevented from entering the underride area of the second vehicle.

17. The method of claim 16, wherein actuating the collision mitigation device comprises raising the first vehicle using an actuator system of the first vehicle.

18. The method of claim 16, wherein actuating the collision mitigation device comprises lowering the second vehicle using an actuator system of the second vehicle.

19. A vehicle comprising:
a surroundings sensor system;
an evaluation unit configured to predict an unavoidable underride collision between the vehicle and a second vehicle based on sensor data obtained by the surroundings sensor system; and
a collision mitigation device configured to be actuated in response to prediction of the unavoidable underride collision, whereby the vehicle is prevented from entering the underride area of the second vehicle.

20. The vehicle of claim 19, wherein the collision mitigation device comprises at least one of an actuator system configured to raise the vehicle, a deployable protective structure configured to extend from the vehicle, or a communication interface configured to transmit a signal to the second vehicle.
